(19) United States
(12) Patent Application Publication
(10) Pub. No.: US 2024/0136082 A1
(43) Pub. Date: Apr. 25, 2024

(54) ADDITIVELY MANUFACTURED COBALT BURNABLE ABSORBER CAPSULES

(71) Applicant: Westinghouse Electric Company LLC, Cranberry Township, PA (US)

(72) Inventors: Caroline E. CURRAN, McMurray, PA (US); Michael D. HEIBEL, Broomfield, CO (US)

(73) Assignee: Westinghouse Electric Company LLC, Cranberry Township, PA (US)

(21) Appl. No.: 18/049,351

(22) Filed: Oct. 24, 2022

(51) Int. Cl. G21G 1/00; B22F 10/28; B33Y 10/00; B33Y 80/00; G21G 1/02

(52) U.S. Cl. CPC G21G 1/001; B22F 10/28; B33Y 10/00; B33Y 80/00; G21G 1/02; B22F 2301/15; G21G 2001/0089; G21G 2001/0094

(57) ABSTRACT

A target assembly for producing synthetic radioisotopes of Cobalt is provided. The target assembly comprises an enclosure and an irradiation target material. The enclosure defines a cavity therein and is comprised of an enriched material configured to have a short half-life upon being exposed to a neutron flux. The irradiation target material is comprised of a precursor to Cobalt-60. A method for producing a target assembly is also provided.

### BACKGROUND

The production of synthetic radioisotopes entails inserting a target material into a target carrier enclosure and an irradiation thereof within an incore instrumentation system for a specified irradiation cycle time. After extracting the target carrier enclosure, the irradiated target material can be recovered and processed into a synthetic radioisotope. However, currently available target carrier enclosures can produce long-lived radioisotopes after undergoing an irradiation cycle, thereby requiring extended periods of storage in spent fuel pools before the target carrier components and any target materials housed therein can be safely handled and/or transported elsewhere for processing/disposal. Issues related to safety and transportation logistics can contribute to the cost of producing synthetic radioisotopes. A need exists to produce the desired radioisotopes without also producing ill-affecting isotopes having long half-lives.

### SUMMARY

The following summary is provided to facilitate an understanding of some of the innovative features unique to the aspects disclosed herein, and is not intended to be a full description. A full appreciation of the various aspects disclosed herein can be gained by taking the entire specification, claims, and abstract as a whole.

In various aspects, a target assembly for producing synthetic radioisotopes of Cobalt is disclosed. In some aspects, the target assembly includes an enclosure defining a cavity therein and an irradiation target material configured to be housed within the cavity of the enclosure. In some aspects, the enclosure is comprised of an enriched material configured to have a short half-life upon being exposed to a neutron flux. In other aspects, the irradiation target material is comprised of a precursor to Cobalt-60.

In various aspects, a method for producing a target assembly is disclosed. In some aspects, the method includes providing a feedstock to a forming process and producing at least one layer of an enclosure of the target assembly from the feedstock with the forming process. In certain aspects, the feedstock comprises an enriched metallic material.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 depicts a partial cross-section view of a nuclear reactor core, in accordance with at least one non-limiting aspect of the present disclosure.

FIG. 2 depicts a cross-sectional schematic representation of an enclosure, in accordance with at least one non-limiting aspect of the present disclosure.

FIG. 3 illustrates results of an irradiation of an enriched material indicating a change in activity level, in accordance with at least one non-limiting aspect of the present disclosure.

FIG. 4 illustrates results of an irradiation of an enriched material indicating a change in activity level, in accordance with at least one non-limiting aspect of the present disclosure.

FIG. 5 illustrates results of an irradiation of an enriched material indicating a change in activity level, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

The term “enriched material” is used herein with reference to a material having an increased amount of at least one stable isotope prior to exposure to any significant neutron flux compared to that of a naturally occurring amount. The term “isotopically pure” is used herein with reference to an enriched material comprising a single isotope at a level greater than 98 mol %, or greater than 99 mol %, or greater than 99.99 mol %, or of about 100 mol %. The term “inert material” is used herein with reference to a material that does not participate in a chemical reaction and/or a nuclear reaction.

Reference throughout the specification to terms “short half-life” and “short-lived radioisotope” are made with reference to half-lives on the order of days. Reference throughout the specification to terms “relatively long half-life” and “long-lived radioisotopes” are made with reference to half-lives on the order of weeks, or on the order of months, or on the order of years.

Synthetic radioisotopes provide a source of nuclear radiation having a known half-life and can have a variety of commercially relevant industrial and/or medical applications. For example, Cobalt-60 (hereinafter “Co-60”) has emerged as a promising radiation source for use in radiation therapy, instrument sterilization, and food spoilage prevention. Co-60 is a relatively long-lived radioisotope of stable Cobalt-59 (hereinafter “Co-59”), decaying with a half-life of about 5.27 years thereby emitting ionizing radiation including beta and/or gamma emissions. The amount of ionizing radiation produced by a radioisotope is typically quantified as an activity level in units of Curies. Other examples of synthetic radioisotopes with commercial applications include Lutetium-177 (hereinafter “Lu-177”) and Actinium-225 (hereinafter “Ac-225”).

Radioisotopes can be produced with a neutron activation process wherein an excited radioactive state is induced via neutron capture in a radioisotope precursor, resulting in an unstable activation product. In the context of commercially useful radioisotopes, a desired radioisotope can be deliberately produced by irradiating a mass of an irradiation target material comprising a precursor to the desired radioisotope in substantial proportions or mass ratios greater than 25%, or greater than 20%, or greater than 15%, or greater than 10%, or greater than 5%, or greater than 2.5%, or greater than 1%. For example, Co-60 can be deliberately produced by irradiating a Co-59 based irradiation target material with a constant neutron flux.

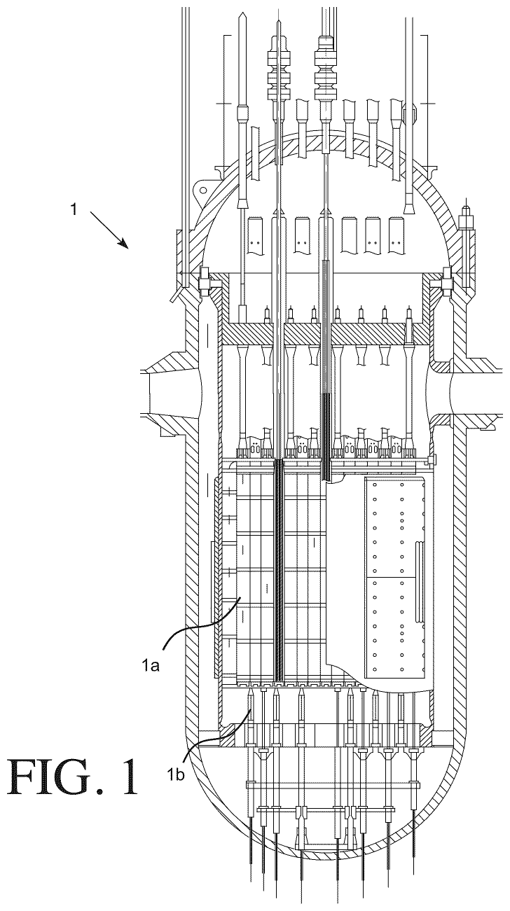

In practice, target assemblies comprising the irradiation target material can be incorporated into a nuclear reactor as burnable absorbers and are irradiated for one or more years. Conventional target assemblies are prepared by inserting small slugs comprised of irradiation target material, such as, for example, Co-59, into an open end of a preformed enclosure. The enclosure is subsequently closed off and the resulting target assembly can be used in a radioisotope production thereafter. For example, FIG. 1 depicts a cross-section view of a nuclear reactor core 1 containing a fuel assembly 1a, in accordance with at least one non-limiting aspect of the present disclosure. The fuel assembly 1a can provide a neutron flux directed into a tubular guide thimble positioned therein and the inner volume of the guide thimble can be accessed through a bottom penetration 1b. During operation of the nuclear reactor core 1, a target assembly can be inserted into the bottom penetration 1b to position the target assembly within the guide thimble of the fuel assembly 1a to expose the target assembly to a neutron-rich environment, thereby providing a neutron flux to the irradiation target material housed within the enclosure to produce a radioisotope of interest. Currently available enclosures are manufactured and/or machined from materials typically found in nuclear reactor components such as, for example, stainless steel.

Radioisotopes can also be incidentally produced in materials containing small quantities of elements susceptible to neutron capture. For example, in the context of nuclear reactors, irradiated stainless steel reactor core components typically comprise trace quantities of Co-60. However, irradiated stainless steels are not useful in any commercial applications requiring Co-60 as a source of nuclear radiation due to the relatively small proportions of Co-60 contained therein. Moreover, the Co-60 content in irradiated stainless steel can still be substantial enough to pose a threat to humans due to the relatively long half-life and decay emission associated with Co-60. Therefore, irradiated stainless steel components must be treated as potentially high level radioactive waste and/or require extended storage times submerged in spent fuel pools prior to reaching activity levels safe enough for handling and/or transportation. The extended storage times required for these irradiated components can present resource allocation issues due to competing radiation sources requiring storage such as, for example, spent fuel assemblies. Additionally, disposal of irradiated components must be closely monitored to avoid contamination of any downstream processes and/or recycled products incorporating scrap metals.

Because of the inherent danger in handling irradiated stainless steels, the use of currently available enclosures in target assemblies can present safety hazards to operators and their environment, thereby complicating the logistics of transportation, disposal, and/or storage of the enclosures. Accordingly, various aspects of the present disclosure provide various methods and devices for producing commercially useful radioisotopes without producing any undesired long-lived radioisotopes, thereby avoiding logistical issues associated with currently available target assemblies.

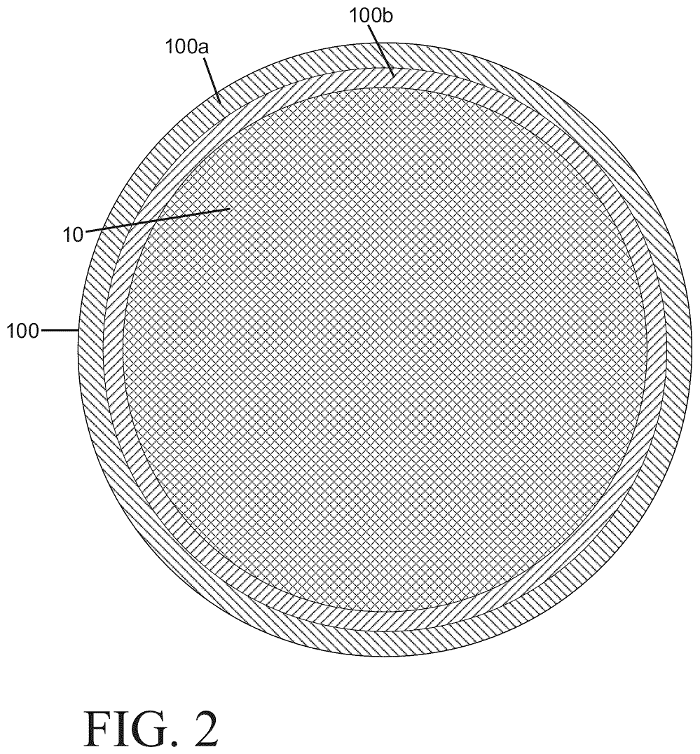

Now referring to FIG. 2, a cross-section view of an enclosure 100 for producing a radioisotope from an irradiation target material in a thimble guide tube of a nuclear reactor core is provided, in accordance with at least one non-limiting aspect of the present disclosure. In some examples, the outer cross-section geometry of the enclosure 100 can be substantially the same as, or slightly smaller than, the inner diameter of a thimble guide tube of a nuclear reactor core. For example, the enclosure 100 can be configured with a substantially cylindrical tubular geometry having an outer diameter of about 0.3 inches, or about 0.25 inches, or about 0.2 inches, or about 0.15 inches. In certain examples, the enclosure 100 includes an outer wall 100a having an outer diameter and an inner diameter. The enclosure 100 can optionally include an inner layer 100b having an outer diameter and an inner diameter. Other configurations of the enclosure 100 are contemplated by the present disclosure. For example, in some implementations, the outer cross-section geometry of the enclosure 100 can be configured as a hexagonal geometry, a rectangular geometry, or any other closed polygonal geometry.

In various examples, the enclosure 100 defines a cavity therein. The cavity of the enclosure 100 is configured to house an irradiation target material. For example, the cavity can be configured with a cross-section geometry substantially the same as, or slightly larger than, a cylindrical slug 10 comprised of an irradiation target material. In some examples, the inner diameter of the outer wall 100a defines the cross-section geometry of the cavity. In examples of the enclosure 100 including the optional inner layer 100b, the inner diameter of the inner layer 100b defines the cross-section geometry of the cavity.

In various examples, the enclosure 100 is comprised of an enriched material. In some examples, the enriched material can include a precursor to a short-lived neutron-activated radioisotope having a half-life of less than one week, or less than 5 days, or less than 1 day. In certain examples, the enclosure 100 can be configured to have a short half-life upon exposure to a neutron flux. For example, the portion of the enclosure 100 materials susceptible to neutron capture can be limited to precursors of short-lived radioisotopes. An enclosure 100 incorporating this configuration can provide an advantage of minimized downtime prior to shipping and/or handling following a period of irradiation with a neutron flux, such as, for example, a duration of time required to produce a medically useful radioisotope with a constant neutron flux, without compromising operator and/or environmental safety. In certain examples, the outer wall 100a of the enclosure 100 can be comprised of the enriched material.

Additionally, the material properties of the enclosure 100 can be configured to reliably house an irradiation target. For example, an outer wall 100a of the enclosure 100 can include the enriched material in combination with chemically separable alloying materials to optimize a mechanical property, such as, for example, strength and/or toughness, and/or a chemical property, such as, for example, corrosion resistance. This configuration is particularly advantageous for prolonging the life of an enclosure 100 in the event that an enclosure 100 is inadvertently exposed to external stresses or if the enclosure 100 is intended to be reused. In some examples, the enclosure 100 comprises alloying materials that are precursors to short-lived radioisotopes. In certain examples, the enclosure 100 is comprised specific isotopes of alloying materials such as, for example, specific isotopes of Copper and/or Nickel. Thus, the composition of the enclosure 100 can be configured to provide the advantages of having a shorter half-life upon irradiation without compromising the structural integrity of the enclosure 100 required to reliably house an irradiation target material, thereby avoiding the safety, logistical and/or economic issues associated with employing conventional irradiation target assemblies for producing synthetic radioisotopes.

The enriched material can be configured as an isotopically pure material. For example, the enriched material can be configured as a precursor to a specific beta-emitting radioisotope with a known half-life. In some examples, the enclosure 100 can include isotopically pure enriched Nickel and/or Copper. In certain examples, the enclosure 100 can include Nickel-64, Copper-63 or Copper-65. Other configurations are contemplated by the present disclosure. For example, in some implementations, the enriched material can be configured as a precursor to an alpha-emitting radioisotope, such as, for example, an isotope of Lead, Thallium and/or Bismuth.

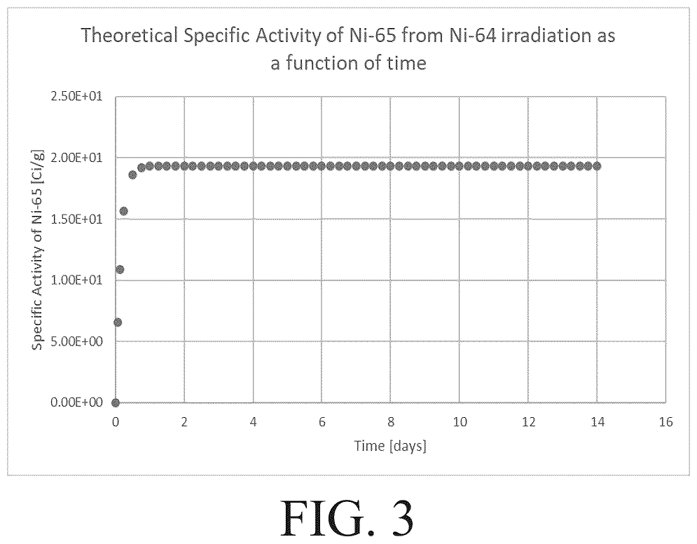

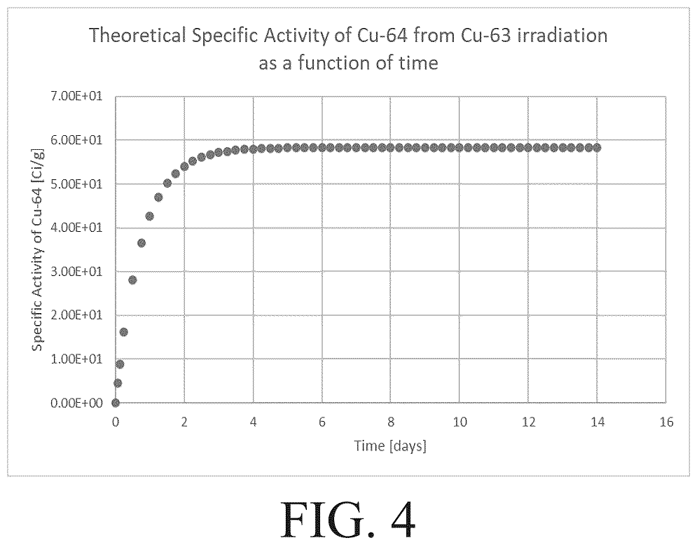

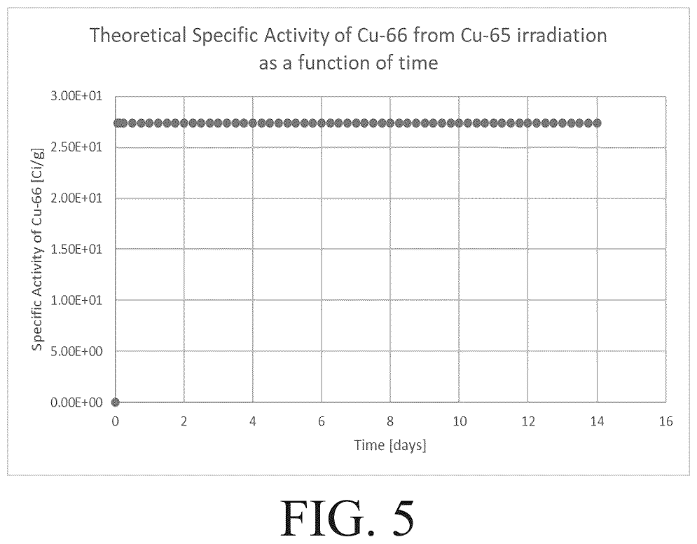

Since an isotopically pure enriched material does not contain more than one isotope of a given element, an irradiation thereof with a constant neutron flux can produce a specific radioisotope of the given element with a defined activity level and/or decay mode. For example, irradiating an enclosure 100 comprising a Copper-65 based enriched material will form Copper-66 which undergoes β⁻ decay with a half-life of less than 1 hour. With respect to specific activity, each of FIGS. 3-5 independently illustrate the theoretical specific activity of Nickel-65, Copper-64 and Copper-66 in Curies/g from irradiating Nickel-64, Copper-63 or Copper-65, respectively, as a function of time. Thus, the composition of an enclosure 100 can be configured to provide a predictable decay behavior, thereby facilitating an optimization of the logistical operations associated with handling an irradiation target assembly following an irradiation thereof.

Since Copper-64, Copper 66, and Nickel-65 are emerging in the market as effective radiopharmaceuticals for cancer treatments, an enclosure comprising Copper-63, Copper-65, or Nickel-64 can itself provide a source of a medical radioisotope upon irradiation with a neutron flux while simultaneously providing a housing for a separate irradiation target material of interest. When an enclosure incorporating one of these enriched materials is employed in a production of a first synthetic radioisotope, such as, for example, Co-60, the activated form of the enriched material can be produced within the timeframe of an irradiation period associated with producing the first synthetic radioisotope to provide a second synthetic radioisotope having a significant activity level. For example, as shown in FIGS. 3-5, a maximum theoretical specific activity of any of Nickel-64, Copper-63 or Copper-65 can be achieved with an irradiation thereof under a constant neutron flux of 5×10¹³ neutrons/cm²-s for an irradiation period of about 4 days, or for about 1 day, or less than 1 day. Thus, an enclosure comprising Nickel-64, Copper-63 or Copper-65 can be incorporated into a process for producing Co-60 to produce increased amounts and/or varieties of synthetic radioisotopes over processes employing conventional enclosures without requiring any significant process parameter modifications thereof.

The present disclosure also provides a target assembly for producing synthetic radioisotopes. The target assembly includes an enclosure and an irradiation target material positioned within a cavity of the enclosure. The enclosure of the target assembly is similar in many respects to other enclosures described elsewhere in the present disclosure, which are not repeated herein at the same level of detail for brevity. In various examples, the enclosure includes an outer wall comprised of an enriched material. In some examples, the enclosure can be comprised of an alloy of an enriched material. In certain examples, the enclosure can include a number of layers surrounding the cavity. The enclosure of the target assembly can be configured similarly to an enclosure 100 as described hereinabove. Thus, the enclosure of the target assembly can be configured to reliably house an irradiation target material and to be inserted into a thimble guide tube of an operating nuclear reactor core without becoming a long-lived radioisotope. Additionally, the enriched material of the enclosure can be configured as an isotopically pure material to provide a predictable decay behavior following an irradiation period. For example, the enriched material can be based on Nickel-64, Copper-63, and/or Copper-65. Thus, the enclosure of the target assembly can be configured to provide a minimized and/or optimized time between irradiation and handling of the irradiated target assembly without suffering from safety and logistics issues associated with conventional enclosures following an irradiation thereof.

In various examples, the irradiation target material of the target assembly includes a precursor to a first radioisotope and the cavity is configured to surround the irradiation target material. The first radioisotope can be configured as a synthetic and/or medical radioisotope. For example, the irradiation target material can comprise a precursor to Co-60 such as, for example, Co-59. In some examples, the irradiation target material can be configured as one or more slugs having a cross-sectional geometry smaller than, or substantially the same as, an inner cavity defined by the enclosure. In the slug configuration of the irradiation target material, the length of each slug can be sized to be less than half of the length of an inner cavity defined by the enclosure. Thus, more than one irradiation target material incorporating this configuration can be positioned within the enclosure. Accordingly, an irradiation target material including a precursor to Co-60 can be housed in an enclosure comprised of Nickel-64, Copper-63, and/or Copper-65 to provide multiple synthetic radioisotope outputs in a process for producing synthetic radioisotopes without requiring multiple irradiation cycles and/or multiple target assemblies.

In some examples, the irradiation target material and the enriched material of the enclosure can be separated by a layer of inert material. The layer of inert material can provide a barrier to physical and/or chemical interactions between an irradiation target material and the enclosure, thereby facilitating a separation thereof in any post-processing following irradiation. Since synthetic radioisotopes begin to decay in the absence of an appropriate radiation source, any delays after the retraction of the target assembly in a neutron activation process can result in a lower activity level of the desired radioisotope upon arriving at a final point of destination, especially in the case of short-lived pharmaceutical radioisotopes. Thus, a target assembly configured with the layer of inert material can optimize the deliverable activity level of a pharmaceutical radioisotope and/or reduce the time required to prepare a shipment thereof by maintaining a boundary between the irradiation target material and the enclosure during an irradiation cycle.

As described herein, the target assembly including an irradiation target material and an enclosure comprised of an enriched material can be incorporated into a radioisotope production method. For example, a method for producing synthetic radioisotopes can include inserting the target assembly into a thimble guide tube, irradiating the target assembly with a neutron flux, and retracting the irradiated target assembly from the thimble guide tube to produce one or more synthetic radioisotopes. In some examples, the enriched material prior to irradiation can include Nickel-64, Copper-63, and/or Copper-65. In certain examples, the irradiated target material comprises Co-60. In one example, the method comprises transporting the one or more synthetic radioisotopes within 1 week, or 5 days, or 3 days, or 2 days, or 1 day or on the same day following the retraction of the target assembly. The radioisotope production method can optionally comprise post-processing of the target assembly after a retraction thereof. For example, the one or more synthetic radioisotopes can undergo a chemical process and/or a mechanical separation to facilitate a transportation or an administration thereof.

As discussed elsewhere in the present disclosure, the target assembly can be configured with various combinations of irradiation target materials and enriched materials to provide multiple product streams and/or enclosures with short half-lives in a process for producing synthetic radioisotopes. Thus, the irradiated target material and/or the irradiated enclosure of the target assembly employed in a pharmaceutical radioisotope production can independently be comprised of one or more pharmaceutical radioisotopes upon an irradiation and/or a retraction thereof. Accordingly, the use of a target irradiation assembly in a method for producing pharmaceutical radioisotopes as disclosed hereinabove can provide increased process flexibility and/or shorter downtime of irradiated enclosures, thereby avoiding any logistical and/or safety issues associated with conventional enclosures.

A method for producing a target assembly is provided by the present disclosure. The method for producing a target assembly includes providing a feedstock to a forming process and producing at least one layer of an enclosure of the target assembly from the feedstock with the forming process. In various examples, the feedstock includes an enriched material. In some examples, the at least one layer produced by the forming process can include an outer wall of the enclosure of the target assembly. In certain examples, the at least one layer produced by the forming process can define a cavity therein. In one example, the forming process produces an outer wall defining a cavity configured to accommodate at least one slug comprised of an irradiation target material. For example, the cavity can be configured with a cross-section geometry substantially the same as, or slightly larger than, a slug comprising an irradiation target material. The length of the cavity can be configured to be substantially the same as, or slightly larger than, the length of at least one slug.

In various examples, the enriched material of the feedstock is a metallic material. In some examples, the enriched material can include an isotopically pure metallic material. In certain examples, the enriched metallic material can include Nickel-64, Copper-63, and/or Copper-65. The composition of the enriched material of the feedstock can be configured similarly to other enriched materials for enclosures described hereinabove. Thus, the feedstock can be configured to provide an outer wall of an enclosure to reliably house an irradiation target material without becoming a long-lived radioisotope following an irradiation thereof.

The method for producing a target assembly can be adapted to incorporate various forms of feedstock material. For example, the feedstock can be configured as a powdered or a granular enriched metallic material. In examples of the method including a powdered configuration of the feedstock, the forming process can be configured to incorporate an additive manufacturing process. In some examples, the forming process can include powder bed fusion and/or laser metal deposition. In certain examples, the forming process can include electron beam melting, selective laser melting and/or direct metal laser sintering. Other configurations of the feedstock are contemplated by the present disclosure. For example, in some implementations, the feedstock can be configured as a wire, a rod, or other continuously conveyable form.

A forming process incorporating additive manufacturing can provide optimized tolerances, sizing and/or geometries of enclosures and/or the cavities defined therein to accommodate various amounts and/or geometries of irradiation target materials while minimizing any void spaces therein. Additionally, since additive manufacturing does not rely on a removal of material to obtain any particular geometry or feature, an incorporation thereof in the forming process can minimize the amount of feedstock material required to produce a given component geometry, thereby avoiding any unnecessary waste of costly enriched materials, such as, for example, isotopically pure Copper and/or Nickel. Thus, a method for producing a target assembly can be configured to avoid wasteful and/or costly manufacturing practices without compromising process flexibility.

The method for producing a target insert assembly can incorporate a core. For example, the at least one layer of the enclosure can be formed around a core comprising at least one irradiation target material. In some examples, the at least one irradiation target material comprises a precursor to Co-60, Lu-177, and/or Ac-225. In certain examples, the core is configured as one or more slugs comprised of an irradiation target material. In one example, the at least one layer of the enclosure is formed around an outer inert layer of a core comprising at least one irradiation target material.

In examples of the method where the at least one layer is formed around a core, the forming process can be adapted to produce a layer of the enclosure directly around and/or on an outer surface of the core to be incorporated into the target assembly. For example, when additive manufacturing is incorporated into the forming process, at least a portion of a known outer surface geometry of the core can be incorporated into the method as a supporting underlying substrate for a layer of the enclosure to be formed around or upon. A forming process incorporating this configuration can produce a closed structure around a core thereby avoiding any separate components for sealing off an exposed portion of the core or the space required thereby. Thus, the forming process can be configured to optimize the utilization of space within a cavity based on a given core to be incorporated therein on a case-by-case basis. Accordingly, the method for producing a target assembly can be configured to maximize the amount of desired radioisotopes produced within a given volume available in a reactor core without compromising process flexibility.

Various aspects of the present disclosure include, but are not limited to, the aspects listed in the following numbered clauses.

Clause 1—A target assembly for producing synthetic radioisotopes of Cobalt. The target assembly comprises an enclosure and an irradiation target material. The enclosure defines a cavity therein and is comprised of an enriched material configured to have a short half-life upon being exposed to a neutron flux. The irradiation target material is comprised of a precursor to Cobalt-60 and is configured to be housed within the cavity of the enclosure.

Clause 2—The target assembly of clause 1, wherein the irradiation target material comprises Cobalt-59.

Clause 3—The target assembly of any one of clauses 1-2, wherein the enriched material is isotopically pure.

Clause 4—The target assembly of any one of clauses 1-3, wherein the enriched material comprises at least one of Nickel-64, Copper-63, or Copper-65.

Clause 5—The target assembly of any one of clauses 1-4, wherein the enriched material is a metallic material.

Clause 6—The target assembly of any one of clauses 1-5, wherein the enriched material comprises an alloy.

Clause 7—A method for producing a target assembly. The method comprises the steps of providing a feedstock to a forming process and producing at least one layer of an enclosure of the target assembly from the feedstock with the forming process. The feedstock comprises an enriched metallic material.

Clause 8—The method of clause 7, wherein the at least one layer comprises an outer wall of the enclosure of the target assembly.

Clause 9—The method of any one of clauses 7-8, wherein the enriched metallic material is comprised of an isotopically pure material.

Clause 10—The method of clause 9, wherein the enriched metallic material comprises Nickel-64, Copper-63, and/or Copper-65.

Clause 11—The method of any one of clauses 7-10, wherein the feedstock is configured as a powder.

Clause 12—The method of any one of clauses 7-11, wherein the forming process comprises an additive manufacturing process.

Clause 13—The method of clause 12, wherein the forming process comprises a powder bed fusion process.

Clause 14—The method of clause 13, wherein the forming process comprises at least one of electron beam melting, selective laser melting, or direct metal laser sintering.

Clause 15—The method of clause 12, wherein the forming process comprises laser metal deposition.

Clause 16—The method of any one of clauses 7-15, wherein the at least one layer is formed around a core comprised of at least one irradiation target material.

Clause 17—The method of clause 16, wherein the core comprises a precursor to at least one of Cobalt-60, Lutetium-177, or Actinium-225.

Clause 18—The method of any one of clauses 16-17, wherein the core comprises Cobalt-59.

Various features and characteristics are described in this specification to provide an understanding of the composition, structure, production, function, and/or operation of the present disclosure, which includes the disclosed methods and systems. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of the present disclosure have been described above for purposes of illustration, it will be evident to those skilled in the art that numerous variations of the details of the present disclosure may be made without departing from the present disclosure as defined in the appended claims.

What is claimed is:

1. A target assembly for producing synthetic radioisotopes of Cobalt, the target assembly comprising:
an enclosure comprised of an enriched material, wherein the enriched material is configured to have a short half-life upon being exposed to a neutron flux, and wherein the enclosure defines a cavity therein; and
an irradiation target material comprised of a precursor to Cobalt-60, wherein the irradiation target material is configured to be housed within the cavity of the enclosure.

2. The target assembly as claimed in claim 1, wherein the irradiation target material comprises Cobalt-59.

3. The target assembly as claimed in claim 1, wherein the enriched material is isotopically pure.

4. The target assembly as claimed in claim 1, wherein the enriched material comprises at least one of Nickel-64, Copper-63, or Copper-65.

5. The target assembly as claimed in claim 1, wherein the enriched material is a metallic material.

6. The target assembly as claimed in claim 5, wherein the enriched material comprises an alloy.

7. A method for producing a target assembly, the method comprising:
providing a feedstock to a forming process, the feedstock comprising an enriched metallic material; and
producing at least one layer of an enclosure of the target assembly from the feedstock with the forming process.

8. The method as claimed in claim 7, wherein the at least one layer comprises an outer wall of the enclosure of the target assembly. The method as claimed in claim 7, wherein the enriched metallic material is comprised of an isotopically pure material.

10. The method as claimed in claim 9, wherein the enriched metallic material comprises Nickel-64, Copper-63, and/or Copper-65.

11. The method as claimed in claim 7, wherein the feedstock is configured as a powder.

12. The method as claimed in claim 7, wherein the forming process comprises an additive manufacturing process.

13. The method as claimed in claim 12, wherein the forming process comprises a powder bed fusion process.

14. The method as claimed in claim 13, wherein the forming process comprises at least one of electron beam melting, selective laser melting, or direct metal laser sintering.

15. The method as claimed in claim 12, wherein the forming process comprises laser metal deposition.

16. The method as claimed in claim 7, wherein the at least one layer is formed around a core comprised of at least one irradiation target material.

17. The method as claimed in claim 16, wherein the core comprises a precursor to at least one of Cobalt-60, Lutetium-177, or Actinium-225.

18. The method as claimed in claim 17, wherein the core comprises Cobalt-59.
